(19) United States
(12) Patent Application Publication
(10) Pub. No.: US 2025/0086470 A1
(43) Pub. Date: Mar. 13, 2025

(54) A METHOD OF TRAINING A MODEL FOR ONE OR MORE PRODUCTION WELLS

(71) Applicant: SOLUTION SEEKER AS, Oslo (NO)

(72) Inventors: Vidar GUNNERUD, Oslo (NO); Bjarne GRIMSTAD, Oslo (NO); Kristian LØVLAND, Oslo (NO)

(21) Appl. No.: 18/726,683

(22) PCT Filed: Jan. 9, 2023
(86) PCT No.: PCT/NO2023/050001

§ 371 Date: Jul. 3, 2024

(30) Foreign Application Priority Data
Jan. 7, 2022 (GB) 2200184.6

(51) Int. Cl. G06N 3/09; G06N 3/0455; G06N 3/084; G06N 3/088; G06Q 50/02

(52) U.S. Cl. CPC G06N 3/09; G06N 3/0455; G06N 3/084; G06N 3/088; G06Q 50/02

(57) ABSTRACT

A method of training a parametric model for describing for one or more production wells a relationship between one or more flow parameters, one or more well parameters and/or an associated status of at least one control point associated with the one or more production wells. The method comprises: minimising an unsupervised loss function for the parametric model based on unlabelled production data; and estimating model parameters of the parametric model based on the minimised unsupervised loss function. The method of training permits use of the large volume of unlabelled production data to provide a parametric model with improved accuracy of modelling the one or more production wells.

The invention relates to a method of training a model for one or more production wells. The invention further extends to a corresponding model. The invention further relates to a method of modelling using the trained model, a method of analysing production performance for one or more production wells, a method of determining predicted production performance for one or more production wells and a method of improving or optimising production performance for one or more production wells. A computer programme product comprising instructions that permit execution of the methods of the invention is also provided by the invention. Similarly, a computer system configured to carry out the methods of the invention is also provided by the invention.

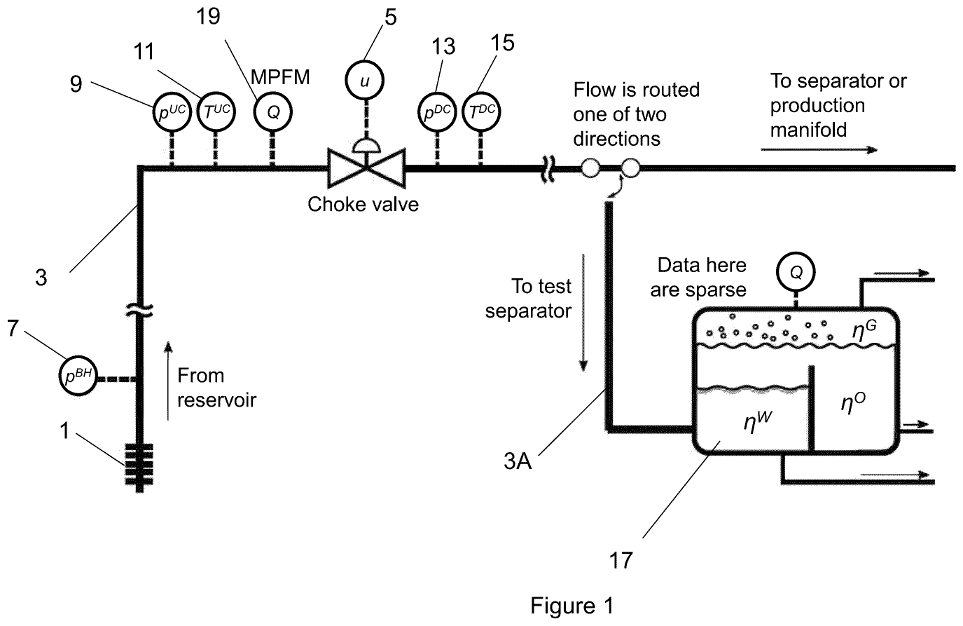

FIG. 1 shows a schematic of a typical production well 1. The production well 1 is connected to a hydrocarbon reservoir (not shown). Hydrocarbons from the reservoir are produced via the well 1 and transferred to a separator or production manifold (not shown) via conduit 3. A choke valve 5 is positioned within the conduit 3 and can be opened and closed to permit and prevent the flow of hydrocarbons from the production well 1.

Situated in proximity to the production well 1 (i.e. “downhole”) is a pressure sensor 7 configured to measure the pressure of the hydrocarbons as they emanate from the production well 1.

In proximity to the choke valve 5 and situated upstream thereof are a pressure sensor 9 and temperature sensor 11. The pressure sensor 9 and temperature sensor 11 are configured to measure the pressure and temperature of the hydrocarbons, respectively, immediately upstream of the choke valve 5.

Also in proximity to the choke valve 5 and situated downstream thereof are a pressure sensor 13 and temperature sensor 15. The pressure sensor 13 and temperature sensor 15 are configured to measure the pressure and temperature of the hydrocarbons, respectively, immediately downstream of the choke valve 5.

The measurements at the pressure sensor 13 and temperature sensor 15 can be compared to the measurements at the pressure sensor 9 and temperature sensor 11 to determine how the choke valve 5 and its degree of opening impacts on the hydrocarbons passing therethrough.

Attached to conduit 3 at a location downstream of the pressure sensor 13 and temperature sensor 15 is a bypass conduit 3A which leads to a test separator 17. When it is desired to carry out a well test, e.g. to measure the flow rate of the fluid produced, the produced hydrocarbons from well 1 can be diverted from the separator or production manifold and to the test separator 17 via bypass conduit 3A. The test separator 17 separates out the produced fluid out into multiple single phases (e.g. water, oil and gas) and then the flow rate of each of these phases is measured.

Well tests are performed on an intermittent basis such that the flow rates for the well 1 can be determined. However, a well test may take several hours (or even days) to complete, and the test separator 17 will typically be used for a large number of wells (i.e. several wells other than production well 1). Routing of produced fluid to the test separator 17 can also result in an impedance of production performance of production well 1. Thus, there are limitations imposed on the frequency with which well tests can be performed. A typical frequency for well testing of a given well is once a month and as such the flow rate data as measured by a well test are relatively scarce.

A multiphase flow meter (MPFM) 19 is also situated proximate and upstream to the choke valve 5. The MPFM 19 hosts multiple different sensors which provide measurements that are fused in a model in real time to estimate flow rates of the fluid produced from the well 1 in real time. As such, flow rate measurements for the production well 1 can be made far more frequently as compared to those determined from a well test using test separator 17.

Multiphase flow meters, such as MPFM 19, are expensive devices to provide. As such, they are not always provided/used since there expense is not always commercially warranted. It is thus far more prevalent for test separators such as test separator 17 to be used to measure flow rates for production wells.

MPFM measurements also tend to be inaccurate and they have limited applicability since they are typically only designed to determine flow rates for a given type of flow regime from the production well. Therefore, if the flow regime slightly differs from that for which the MPFM was designed then the measurements of flow rate may be associated with significant inaccuracies.

There are hence drawbacks associated with the flow rate measurement techniques used in the art.

To overcome or at least partly moderate drawbacks in measuring well flow rates both with MPFMs and with well tests using test separators, production well modelling has become more commonplace in recent years, and in particular data driven modelling techniques. Such modelling techniques have also been applied more generally for production wells in order to model other well parameters, flow parameters and information on control points associated with production wells (e.g. choke valves). Exemplary data driven modelling techniques are disclosed, for example, in the applicant's own patent publication: WO 2019/110851 A1.

Data modelling techniques are valuable since they allow a variable or parameter (e.g. flow rate) of interest to be modelled in absence of a ‘complete’ set of measurements for that given variable/parameter. Thus, drawbacks associated with infrequency of measurement and inaccuracies in measurement associated with, e.g., MPFM and well test techniques for determining flow rates as discussed above are not equally shared by data modelling techniques and hence these drawbacks in MPFM/well test techniques can be moderated by using data-driven modelling in parallel with these measurement techniques. That is, the resultant model from the data driven modelling techniques can be used in support of the MPFM/well test techniques and can be used to provide predictions/estimates in the intervals where no measurement data exists or as a back-up if a measurement (e.g. MPFM) device fails.

Known data driven models which are used to model a given parameter are generated based on data previously recorded for that parameter. The resultant models can then be used to give estimates, predictions etc. of that parameter at, for example, a time where no measurement data for that parameter exists. An example of this is known data driven flow rate models that are trained based on recorded flow rate data. These models are necessarily reliant on the data recorded using MPFMs and/or well test separators and thus are affected indirectly by the poorness of the data available via these methods (e.g. infrequent and inaccurate data).

Improvements in data driven modelling techniques for modelling production wells are thus desired.

In accordance with a first aspect of the invention, there is provided a method of training a parametric model for describing for one or more production wells a relationship between one or more flow parameters, one or more well parameters and/or an associated status of at least one control point associated with the one or more production wells, the method comprising: minimising an unsupervised loss function for the parametric model based on unlabelled production data; and estimating model parameters of the parametric model based on the minimised unsupervised loss function (i.e. estimating model parameters of the parametric model based on minimising the unsupervised loss function). The estimation of the model parameters based on the minimised unsupervised loss function may thereby improve the accuracy with which the parametric model describes for the one or more production wells the relationship between the one or more flow parameters, the one or more well parameters and/or the associated status of at least one control point.

It has been realised by the inventors that whilst, in the context of production wells, there may be infrequent/unreliable data recorded relating to the flow parameter, well parameter and/or control point status to be modelled (i.e. there may be infrequent ‘labelled’ data), other, unlabelled data associated with production wells may be extremely prevalently and frequently recorded. For instance, with reference to FIG. 1, whilst the flow rate data recorded by the test separator 17 is infrequently collected and whilst the flow rate data recorded by the MPFM 19 may be inaccurate (and in fact may not always be available given, as above, MPFMs are not commonly used), the temperature and pressure sensors 7, 9, 11, 13 and 15 collect their data extremely frequently and this data is not associated with any notable inaccuracy (and in fact this data is typically highly accurate). Sensors 7, 9, 11, 13 and 15 may, for example, record data relating to temperature and pressure between 1 and 60 times a minute and may give an effectively continuous, real time measurement of their respective variables. Thus, as compared with the measurements of flow rate from the well test separator/MPFM, this data is far more abundantly available.

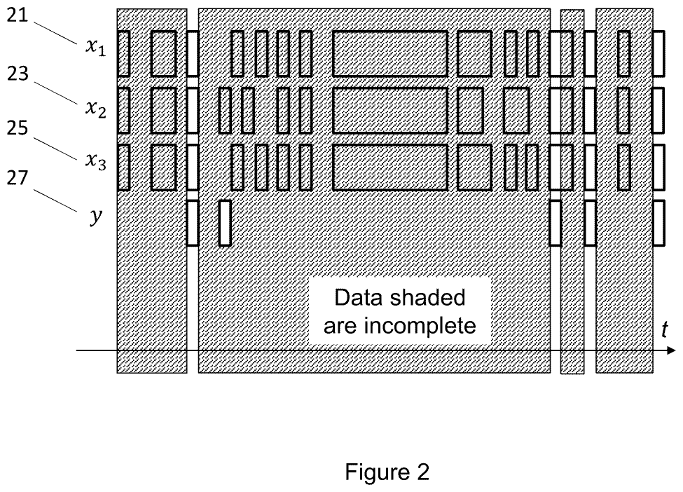

FIG. 2 is a schematic that illustrates the above concept. In particular, FIG. 2 shows the availability of recorded data 21, 23, 25 and 27 associated with a production well over time. Reference numbers 21, 23, 25 are used to denote variables for which data is frequently collected. For instance, with reference to FIG. 1, data 21 can be considered as the temperature data collected from temperature sensor 11, data 23 can be considered as the data collected from pressure sensor 13, whilst the data 25 can be considered as the data collected from temperature sensor 15. Reference number 27 is used to denote a flow parameter, well parameter and/or control point status associated with the production well for which data is infrequently collected (or indeed not collected at all). For instance, with reference to FIG. 2, data 27 can be considered as flow rate data as collected at the test separator 17.

As shown, data 21, 23, 25 are far more prevalently available than data 27. There are significant periods of time where at least one of data 21, 23 and 25 has been recorded/collected but where data 27 has not, and in fact, as shown, it is a majority of the time where one of data 21, 23 and 25 is available and data 27 is not. Where data 21, 23 and 25 are available but data 27 is not the data is considered as being ‘unlabelled’. That is, where some data relating to the production well is available but data relating to the flow parameter(s), well parameter(s) and/or control point(s) of interest (i.e. to be modelled) is not, the data is considered unlabelled. Where data 27 is available in addition to one or more of data 21, 23, 25 is available the data is considered as being labelled—i.e. where data relating to the flow parameter(s), well parameter(s) and/or control point(s) of interest is available in addition to other data relating to production wells.

In prior art data modelling techniques for modelling production wells conventionally only labelled data has been used to train production well models for describing a relationship between one or more flow parameter(s), one or more well parameter(s) and/or control point(s) of interest. Conventionally unlabelled data has been disregarded. This is because the means used to train such prior art models relied on the evaluation of a supervised loss function which required complete, labelled data. As such, it was assumed that knowledge of (i.e. data relating to) the flow parameter(s), well parameter(s) and/or control point(s) to be modelled was required in order to train a model for modelling said flow parameter(s), well parameter(s) and/or control point of interest(s). Thus, all the unlabelled data available for a production well has been effectively ignored in the prior art modelling techniques.

It has been non-obviously realised however that it is not required to ignore the unlabelled data and that in fact the unlabelled data can be used to train, at least in part, a model capable of describing for one or more production wells a relationship between one or more flow parameters, one or more well parameters and/or an associated status of at least one control point associated with the one or more production wells. This is achieved by minimising an unsupervised loss function for the model based on unlabelled production data and subsequently estimating model parameters based on the minimised unsupervised loss function to thereby obtain a trained model that may more accurately describe a relationship between one or more flow parameters, one or more well parameters and/or an associated status of at least one control point associated with the one or more production wells.

Thus, the invention of the first aspect can make use of the far more prevalently available unlabelled production data to train the model. There is no need to rely solely on the labelled production data and as such an improved model (e.g. having improved accuracy) can be achieved by the method of the first aspect since large volumes (as demonstrated in FIG. 2) of previously disregarded data can be used in its training for improvements in the model.

As noted above, unlabelled production data in the context of the invention may be considered as production data where some data relating to the production well(s) is available but data relating to the flow parameter(s), well parameter(s) and/or control point(s) of interest (i.e. to be modelled) is not. That is, the unlabelled data has not been designated (or ‘labelled’) with the flow parameter, well parameter and/or control point of interest since such data is unavailable (e.g. to the fallout or absence of a sensor for collecting that data) in the instance at which the unlabelled data is recorded.

Since the training of the method of the first aspect is reliant on the minimisation of only an unsupervised loss function, the training may be considered unsupervised learning.

However, the method may additionally comprise minimising a supervised loss function for the parametric model based on labelled production data and estimating model parameters of the parametric model based on the minimised supervised loss function (i.e. estimating model parameters of the parametric model based on minimising the supervised loss function). In this way, the model can be trained both on the labelled data (i.e. as in prior art modelling techniques) and unlabelled production data and as such an overall improved model can be obtained as compared to prior art models since a far greater volume of data can be used to train the model.

Where both the minimisation of a supervised and an unsupervised loss functions are used in the training of the parametric model, the training may be considered as semi-supervised learning since it requires the minimisation of a supervised and an unsupervised loss function.

The step of minimising a supervised loss function for the parametric model based on labelled production data and estimating model parameters of the parametric model based on the minimised supervised loss function may occur before or after (i.e. separately to) the step of minimising an unsupervised loss function for the parametric model based on unlabelled production data and estimating model parameters of the parametric model based on the minimised unsupervised loss function.

The method may comprise a plurality of steps of minimising an unsupervised loss function for the parametric model based on unlabelled production data and estimating model parameters of the parametric model based on the minimised unsupervised loss function.

The method may comprise a plurality of steps of minimising a supervised loss function for the parametric model based on labelled production data and estimating model parameters of the parametric model based on the minimised supervised loss function.

In scenarios where the method comprises a plurality of steps of minimising a supervised loss function and a plurality of steps of minimising an unsupervised loss function, each of the plurality steps of minimising a supervised loss function for the model based on labelled production data may occur in the alternate (i.e. occur in turn repeatedly) with a respective one of the plurality of steps of minimising an unsupervised loss function for the model based on unlabelled production data. For example, the method may comprise first minimising an unsupervised loss function for the parametric model based on unlabelled production data and estimating model parameters of the parametric model based on the minimised unsupervised loss function, then the method may comprise minimising a supervised loss function for the parametric model based on labelled production data and estimating model parameters of the parametric model based on the minimised supervised loss function, the method may then comprise again minimising an unsupervised loss function for the parametric model based on unlabelled production data (e.g. different unlabelled production data) and estimating model parameters of the parametric model based on the minimised unsupervised loss function and then again minimising a supervised loss function for the parametric model based on labelled production data (e.g. different labelled production data) and estimating model parameters of the parametric model based on the minimised supervised loss function, and (optionally) so on. As such, the training of the model based on the labelled and unlabelled production data can be said to be carried out in an alternating and/or iterative fashion.

The steps of minimising a supervised loss function and an unsupervised loss function may be comprised as part of a single step of minimising a total loss function. The steps of estimating model parameters of the parametric model based on the minimised unsupervised loss function and based on the minimised supervised loss function may be comprised as part of a single step of estimating model parameters of the parametric model based on the minimised total loss function (i.e. estimating model parameters of the parametric model based on minimising the total loss function).

The unsupervised loss function, e.g. the minimised unsupervised loss function, may be generated as part of a consistency training. Worded alternatively, the unsupervised loss function may be set-up such that it can be used to conduct consistency training. The consistency training may thereby permit the minimised unsupervised loss function to be obtained. Accordingly, the method may comprise carrying out a consistency training to thereby minimise the unsupervised loss function. In consistency training, it is assumed that adding a small amount of random noise to an input data point does not change the true output label. By training a model on this loss function, the model can learn to behave robustly on the input data it will be given in the future.

The unsupervised loss function may be generated as part of a contrastive learning. Contrastive learning comprises contrasting data samples against each other to learn attributes that are common between data samples and attributes that set data samples apart from one another.

The unsupervised loss function and the parametric model may be comprised as part of an autoencoder, optionally a variational autoencoder. That is to say, the unsupervised loss function and the parametric model may be set up as an autoencoder/variational autoencoder.

One, several or all of the step(s) of minimising a loss function (i.e. any one of the supervised, unsupervised or total loss functions) as discussed above may comprise a gradient descent method.

The step(s) of minimising an unsupervised loss function, minimising a supervised loss function and/or minimising a total loss function for the model; and the subsequent step(s) of estimating model parameters of the parametric model based on the minimised unsupervised, supervised and/or total loss function(s) may be considered to form part of a regression problem/task (i.e. a regression analysis). A regression problem is distinct from a classification problem or a clustering problem.

The parametric model may be for describing for a plurality of production wells a relationship between one or more flow parameters, one or more well parameters and/or an associated status of at least one control point.

The parametric model may comprise context specific model parameters that are each representative of properties common to the context to which they relate. The context specific parameters may be the parameters that are estimated based on the minimised unsupervised, supervised and/or total loss function.

The context may be a well and hence the context specific parameter may a well-specific parameter.

The context may be a set of wells and hence the context specific parameter may be a parameter specific to a set of wells. Each set of wells may be wells connected to a common hydrocarbon reserve (or reservoir), or form part of the same production field, or which each experience common production behaviours etc. More generally, the set of wells may be defined as a plurality of wells sharing a common configuration.

The parametric model may be for describing for one or more production wells a plurality of relationships between one or more flow parameters, one or more well parameters and/or an associated status of the at least one control point.

The parametric model may comprise a plurality of task specific model parameters that are each representative of properties common to the task to which they relate. The context specific parameters may be the parameters that are estimated based on the minimised unsupervised, supervised and/or total loss function.

The task may be flow rate estimation and hence the model may comprise flow rate estimation specific parameters.

The unlabelled data and/or labelled data may be data measured directly from the production well(s) without any pre-processing, filtering etc. This type of ‘raw’ data is often gathered into a real-time database by an operator for a production well, and is stored as a record of operation.

The labelled and/or unlabelled data may additionally and/or alternatively be data resulting from a mining and/or compaction of original, raw data. Compacted data may be derived from the large volumes of raw data that are recorded in relation with oil and gas production wells, which then may be categorised and compacted based on the categorisation of datasets within the time intervals and by the use of statistics. The resulting statistical data may represent certain aspects of the original data in a far more compressed form, and it can also be more readily searched in order to identify events or patterns of events. This statistical data may be stored in a compact database, and the labelled and/or unlabelled can be drawn from/derived from this compact database. The statistical data may provide information concerning the operation and behaviours of the one or more production wells without the need for all the raw, original data. Methods of data compaction for production well data are described in the Applicant's patent publications WO 2017/077095 A1 and WO 2018/202796 A1. The methods disclosed in these publications may be used to provide a compacted data set that forms the basis of the labelled and/or unlabelled data of the invention.

For instance, to obtain the unlabelled and/or labelled data, the method of the first aspect may comprise (1) gathering historical data and/or live data relating to the status of the at least one control point associated with the one or more production wells, relating to one or more flow parameters in one or more flow path(s) associated with the one or more production wells, and/or relating to one or more well parameters of the one or more production wells; (2) identifying time intervals in the data during which the control points, the flow parameter(s) and/or the well parameter(s) are in a steady state; and (3) extracting statistical data representative of some or all steady state intervals identified in step (2) to thereby represent the original data from step (1) in a compact form. The unlabelled and/or labelled data used in the minimisation of the supervised, unsupervised or total loss function(s) may then be obtained from the data in compact form.

Additionally and/or alternatively, to obtain the unlabelled and/or labelled data, the method of the first aspect may comprise: (1) gathering data covering a period of time relating to one or more flow parameters, one or more well parameters and/or an associated status of the at least one control point associated with the one or more production wells; (2) identifying multiple time intervals in the data during which the at least one control point, the one or more flow parameters and/or the one or more well parameters can be designated as being in a category selected from multiple categories relating to different types of stable production and multiple categories relating to different types of transient events, wherein the data hence includes multiple datasets each framed by one of the multiple time intervals; (3) assigning a selected category of the multiple categories to each one of the multiple datasets that are framed by the multiple time intervals; and (4) extracting statistical data representative of some or all of the datasets identified in step (2) to thereby represent the original data from step (1) in a compact form including details of the category assigned to each time interval in step (3).

The unlabelled and/or labelled data used in the minimisation of the supervised, unsupervised or total loss function(s) may then be obtained from the data in the compact form.

In some circumstances the compaction of the data at step (4) of the above described compaction technique is not implemented and the steady state intervals may instead be used directly as a form of compacted data and as the basis of the labelled and/or unlabelled data used in the minimisation of the supervised, unsupervised and/or total loss function(s).

The at least one control point may be a means/mechanism capable of applying a controlled adjustment to the one or more production wells, in particular an adjustment to the flow of fluid from the production well(s) (e.g. the control point may be capable of applying an adjustment to one or more flow parameters). The adjustment may be in any suitable parameter of the fluid, such as a flow and/or pressure of the fluid. For example, suitable control points may include flow control valves, pumps, compressors, gas lift injectors, expansion devices and so on. The basic principle of the method of the first aspect is compatible with any control that can apply an adjustment within a conduit associated with the one or more production wells. The adjustments need not only be in flow rate or pressure but may include other parameters, such as a level in a subsea separator and ESP pump setting.

The at least one control point may comprise at least one of a flow control valve; a pump; a compressor; a gas lift injector; an expansion device; a choke control valve; gas lift valve settings or rates on wells or riser pipelines; ESP (Electric submersible pump) settings, effect, speed or pressure lift; down hole branch valve settings, down hole inflow control valve settings; or topside and subsea control settings on one or more: separators, compressors, pumps, scrubbers, condensers/coolers, heaters, stripper columns, mixers, splitters, chillers.

The flow parameters may be properties/characteristics/parameters/behaviours relating to the nature of the flow of the fluid, or these may be properties/characteristics/parameters/behaviours relating to the nature of the fluid itself. As such, the flow parameters may include one or more of pressure; flow rate, a gas flow rate, an oil flow rate, a water flow rate a liquid flow rate, a hydrocarbon flow rate, a multiphase flow rate, a flow rate that is the sum of one or more of any of the previously mentioned rates (by volume, mass or flow speed); an oil fraction, a gas fraction, a carbon dioxide fraction, a multiphase fluid fraction, a hydrogen sulphide fraction, temperatures, a ratio of gas to liquid, densities, viscosities, molar weights, pH, water cut (WC), productivity index (PI), Gas Oil Ratio (GOR), BHP and wellhead pressures, rates after topside separation, separator pressure, other line pressures, flow velocities or sand production. It will be appreciated that the flow parameters of interest would not necessarily include all possible flow parameters associated with a production well. Instead the flow parameters may include a selected set of flow parameters that are considered important to the performance of the production well. The flow parameters may be parameters that are impacted, either directly or indirectly, by the status of the at least one control point and/or the well parameters.

The flow parameters may be parameters that are capable of being measured (i.e. parameters which are readily and commonly measured in connection with production wells by appropriate associated equipment) and/or flow parameters that are not capable of being measured (i.e. which have no associated recording equipment and/or those which are physically or practically difficult or impossible to measure directly).

The well parameters may include one or more of: depth, length, number and type of joints, inclination, cross-sectional area (e.g. diameter or radius) within/of a production well, wellbore, well branch, pipe, pipeline or sections thereof; choke valve Cv-curve; choke valve discharge hole cross-sectional area; heat transfer coefficient (U-value); coefficients of friction; material types; isolation types; skin factors; and external temperature profiles. The well parameters may additionally and/or alternatively be one or more of the ‘near well’ reservoir parameters. That is, the well parameters may include parameters of the reservoir to which the well is attached and which directly impact on the performance and behaviour of the well. Such near well reservoir parameters, which can be extracted from production well tests, may include: well productivity index, well skin factor, reservoir permeability, reservoir specific storage, reservoir boundaries.

The method of the first aspect may comprise collecting the labelled and/or unlabelled data that is later used in the minimisation of the supervised, unsupervised and/or total loss function(s). The collecting of the labelled and/or unlabelled data may comprise recording and, optionally, storing the data.

The collecting/recording of the labelled and/or unlabelled data may comprise sensing or measuring using one or more sensors, meters and/or measurement devices in association with the one or more productions wells. For example, one or more pressure sensor(s), temperature sensors(s), flow meter(s) (e.g. flow meters provided at a test separator associated with the one or more production wells), multiphase flow meter(s), and/or any other sensor(s)/measurement device(s)/meter(s) typically used to record data associated with production wells.

The step of storing the data may comprise storing the data in a computer memory (e.g. volatile memory, non-volatile memory or semi-volatile memory).

The step of collecting the labelled and/or unlabelled data may occur prior to the optional mining and/or compaction of the data as described above. Alternatively, no compaction may occur and the collected labelled and/or unlabelled data may be used in its ‘raw’ form for the minimisation of the unsupervised loss function(s), the supervised loss function(s) and/or the total loss functions(s).

In a second aspect of the invention, there is provided a method of modelling for one or more production wells a relationship between one or more flow parameters, one or more well parameters and/or an associated status of at least one control point. The method of the second aspect comprises either: (i) training a parametric model for describing for one or more production wells a relationship between one or more flow parameters, one or more well parameters and/or an associated status of at least one control point associated with the one or more production wells in accordance with the first aspect of the invention, optionally in accordance with any optional form thereof; and subsequently modelling for the one or more production wells a relationship between one or more flow parameters, one or more well parameters and/or an associated status of at least one control point using the trained parametric model; or (ii) using a parametric model trained in accordance with the method of the first aspect, optionally in accordance with any optional form thereof, to model for the one or more production wells a relationship between one or more flow parameters, one or more well parameters and/or an associated status of at least one control point using the trained parametric model.

The parametric model trained in the method of the first aspect of the invention may subsequently be used to provide estimations relating to the one or more flow parameter(s), the one or more well parameter(s) and/or status of the at least one control point for the one or more production wells. For example, the model may be used to provide estimations of flow rate, oil flow rate, gas flow rate, water flow rate, temperatures, pressures, flow composition etc. In that way, the model can effectively be used as a ‘soft’ or ‘virtual’ sensor.

Similarly, the modelling carried out in the method of the second aspect may be a method of estimating one or more flow parameter(s), one or more well parameter(s) and/or the status of at least one control point for the one or more production wells. Accordingly, the method of the second aspect can be considered as a method of ‘soft’ or ‘virtual’ sensing, particularly in a scenario where no actual measurement of the estimated value(s) exist(s).

The method of estimating the one or more flow parameter(s), the one or more well parameter(s) and/or the status of the at least one control point for the one or more production wells may comprise estimating the flow parameter(s), well parameter(s) and/or the status of the at least one control point for a given point in time. The point in time may be a present or future point in time, or a past point in time as discussed in further detail below. The point in time may be an instantaneous point in time, or may be a period of time, e.g. 1 minute, 2 minutes, 5 minutes, 10 minutes, 30 minutes, 1 hour, 2 hours, 5 hours, 10 hours, 12 hours, 1 day, 2 days, 5 days, 1 week, 2 weeks, 3 weeks, 1 month and/or any period of time within the range of 1 minute to 1 month.

The method of estimating the one or more flow parameter(s), the one or more well parameter(s) and/or the status of the at least one control point for the one or more production wells may be a method of estimating past flow parameter(s), past well parameter(s) and/or a past status of the at least one control point for the one or more production wells. That is to say, the method may estimate flow parameter(s), well parameter(s) and/or the status of the at least one control point from a previous point in time. Thus, the method may be used to backfill data (i.e. fill in for missing data from the past) related to the flow parameter(s), the well parameter(s) and/or the status of the at least one control point. This may be useful in scenarios where that data is otherwise unavailable, e.g. because no appropriate sensor/measurement device is available for recording said data or because no data was recorded at a given time for that data (e.g. due to sensor dropout or because no recoding was taken at the given time).

The method of estimating the one or more flow parameter(s), the one or more well parameter(s) and/or the status of the at least one control point for the one or more production wells may be a method of estimating present or future flow parameter(s), present or future well parameter(s) and/or a present or future status of the at least one control point for the one or more production wells.

Estimations are useful as they allow for determinations to be made regarding the flow parameter(s), the well parameter(s) and/or the status of the at least one control point for the one or more production wells. These determinations can then be used to make inferences and assessments in connection with the production well(s) and its/their performance—i.e. they allow past, present or future performance of the production well(s) to be analysed.

In a third aspect of the invention, there is provided a method of analysing production performance for one or more production wells, the method comprising estimating one or more flow parameter(s), one or more well parameter(s) and/or the status of at least one control point for the one or more production wells in accordance with the optional form(s) of the second aspect of the invention as described previously; and analysing production performance for the one or more production wells based on the estimated flow parameter(s), well parameter(s) and/or the status of at least one control point.

The parametric model trained in the method of the first aspect of the invention may subsequently be used to provide predictions of one or more potential future (i.e. hypothetical) flow parameter(s), one or more potential future (i.e. hypothetical) well parameter(s) and/or a potential future (i.e. hypothetical) status of the at least one control point.

Equally, the modelling carried out in the method of the second aspect may be a method of predicting potential future (i.e. hypothetical) flow parameter(s), well parameter(s) and/or a status of the at least one control point for the one or more production wells.

The method of predicting potential future flow parameter(s), well parameter(s) and/or a status of the at least one control point for the one or more production wells may comprise predicting the flow parameter(s), well parameter(s) and/or a status of the at least one control point for a given point in time. The point in time may be an instantaneous point in time, or may be a period of time, e.g. 1 minute, 2 minutes, 5 minutes, 10 minutes, 30 minutes, 1 hour, 2 hours, 5 hours, 10 hours, 12 hours, 1 day, 2 days, 5 days, 1 week, 2 weeks, 3 weeks, 1 month and/or any amount of time within the range of 1 minute to 1 month.

Predictions give an indication of how a hypothetical change (i.e. a proposed or theoretical change) in the status of the at least one control point, one or more well parameter(s) and/or one or more flow parameter(s) impacts on one or more flow parameter(s), one or more well parameter(s) and/or a status of the at least one control point for any of the one or more production wells. Thus, proposed or theoretical predictions and/or developments can be determined. These predictions can then be used to determine an improved or optimised state for a production well (i.e. one in which production is optimised) since it can be determined what state of the production well provides improved production performance.

In a fourth aspect of the invention, there is provided a method of determining predicted production performance for one or more production wells, the method comprising: (i) providing a proposed change in the status of the at least one control point, one or more well parameter(s) and/or one more flow parameter(s) associated with the one or more production wells; (ii) predicting one or more flow parameter(s), one or more well parameter(s) and/or the status of at least one control point for the one or more production wells in accordance with the optional form(s) of the second aspect of the invention set out above based on the proposed change; (iii) determining predicted production performance for the one or more production wells based on the predicted flow parameter(s), well parameter(s) and/or the status of the at least one control point.

The method of the fourth aspect may comprise (iv) repeating steps (i) to (iii) until a desired improvement in production performance is determined. The desired improvement may be an improvement that an operator/engineer deems sufficient/suitably large, for example an improvement sufficiently large such that the operator/engineer is willing to implement for the production wells the proposed change in the status of the at least one control point, one or more well parameter(s) and/or one more flow parameter(s) associated with the one or more production wells in order to improve their performance. For example, the desired improvement may be an improvement in production performance of 1% or more, 5% or more, 10% or more, 25% or more, 50% or more etc. The production performance may be an improvement of any one of the flow parameter(s), well parameter(s) and/or the status of the at least one control point. As an example, the production performance may be a volume or rate of produced hydrocarbons (oil and/or gas).

The method of the fourth aspect may comprise (iv) repeating steps (i) to (iii) until optimised production performance is determined. Optimised production performance may be the peak or prime production performance that is obtainable.

In a fifth aspect of the invention there is provided a method of improving or optimising production performance for one or more production wells, the method comprising: determining improved or optimised production performance for the one or more production wells in accordance with the optional forms of the fourth aspect of the invention; and altering the one or more flow parameter(s), the one or more well parameter(s) and/or the status of the at least one control point associated with the one or more production wells for conformity with the predicted one or more flow parameter(s), the predicted one or more well parameter(s) and/or the predicted status of the at least one control point that give rise to improved or optimised production performance.

Where estimation and prediction differ is that the estimation relates to a state of one or more production well(s) that has occurred, is occurring or will occur or is likely to have occurred, likely is occurring or likely to occur. That is to say, the estimation relates to a state of a well (or wells) that has been, is currently or will be should the well(s) be left to develop on its own accord. The prediction relates to hypothetical changes with respect to the state of a well (or wells) and thus can, and may, include states of a well (or wells) that have not occurred at any time in the lifetime of the well (or wells), nor will they occur upon natural development of a well (or wells) under its current state.

The estimations/predictions made by the method of the second aspect in its optional forms using the parametric model may, as discussed above, comprise providing estimated/predicted flow parameter(s), well parameter(s) and/or the estimated/predicted status of the at least one control point. The estimated/predicted flow parameter(s), well parameter(s) and/or the estimated/predicted status of the at least one control point may be a well health indicator, a water cut (WC) of the produced hydrocarbon fluid, a gas to oil ratio (GOR) of the produced fluid, a liquid loading risk indicator, a total produced fluid flow rate (by volume, mass or flow speed/velocity), a gas flow rate, an oil flow rate, a water flow rate, a liquid flow rate, a hydrocarbon flow rate, a carbon dioxide fluid flow rate, a hydrogen sulphide fluid flow rate, a multiphase fluid flow rate, a slug severity, an oil fraction, a gas fraction, a water fraction, a carbon dioxide fraction, a multiphase fluid fraction, a hydrogen sulphide fraction, a ratio of gas to liquid, density, viscosity, pH, productivity index (PI), BHP and wellhead pressures, rates after topside separation, separator pressure, other line pressures, flow velocities or a sand production. The estimated/predicted flow parameter, well parameter and/or the estimated/predicted status of the at least one control point may additionally and/or alternatively be any of those flow parameters, well parameters and/or a status of those control points set out above.

The one or more one or more production wells as discussed herein may be one or more existing production wells. That is, the one or more production wells may already be in existence and used for production purposes (i.e. production of oil and/or gas). The existing well(s) may thus be considered as well(s) in operation. Data related to production performance (e.g. data relating to one or more flow parameter(s), one or more well parameter(s) and/or an associated status of at least one control point) of the existing production well(s) may already have been recorded and/or in existence. Existing production wells are distinct from proposed or planned wells, which do not exist and hence cannot have any previous production performance and/or production data associated with them.

Any of the first to fifth aspects of the invention described above, including the optional forms thereof, will necessarily have to be implemented on a computer system of sorts. That is to say, the above described methods of the first to fifth aspects are each necessarily entirely computer implemented methods. The method of the fifth aspect may also be entirely implemented as a computer implemented method, though the step of altering the one or more flow parameter(s), the one or more well parameter(s) and/or the status of the at least one control point may not necessarily be (entirely) computer implemented. For example, an operative may make the alteration to the one or more flow parameter(s), the one or more well parameter(s) and/or the status of the at least one control point associated with the one or more production wells.

In a sixth aspect of the invention, there is provided a parametric model for describing for one or more production wells a relationship between one or more flow parameter(s), one or more well parameter(s) and/or an associated status of at least one control point associated with the one or more production wells, wherein the parametric model has been trained in accordance with the first aspect of the invention as set out above, optionally in accordance with any optional feature thereof.

In a seventh aspect of the invention, there is provided a computer system for training of a parametric model for describing for one or more production wells a relationship between one or more flow parameter(s), one or more well parameter(s) and/or an associated status of the at least one control point, wherein the computer system is configured to perform the method of the first aspect, optionally inclusive of any optional features thereof.

In an eighth aspect of the invention, there is provided a computer system configured to perform the method of one or more of the second to fifth aspects of the invention, optionally in accordance with any optional forms thereof.

In a ninth aspect of the invention, there is provided a computer program product comprising instructions for execution on a computer system, wherein the instructions, when executed, will configure the computer system to carry out a method of any of the first to fifth aspects, optionally in accordance with any optional forms thereof.

It will be understood that the minimisation of a/the supervised, unsupervised or total loss function(s) as discussed herein can be achieved by maximisation of the correspondent negative form of the supervised, unsupervised or total loss function(s) (i.e. the reflection of the supervised, unsupervised or total loss function(s) and/or the ‘reward’ function(s) correspondent to the supervised, unsupervised or total loss function(s)). Thus, a maximisation of the correspondent negative form of a/the supervised, unsupervised or total loss function(s) function(s) is, at least indirectly, a minimisation of a/the supervised, unsupervised or total loss function(s).

Certain embodiments of the invention will now be described, by way of example only, and with reference to the accompanying figures, in which:

FIG. 1 is a schematic a conventional production well;

FIG. 2 is an illustration of availability of recorded data associated with a production well over time;

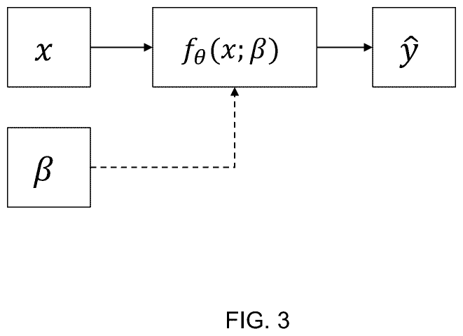

FIG. 3 depicts a multi-task training regime for a parametric model; and

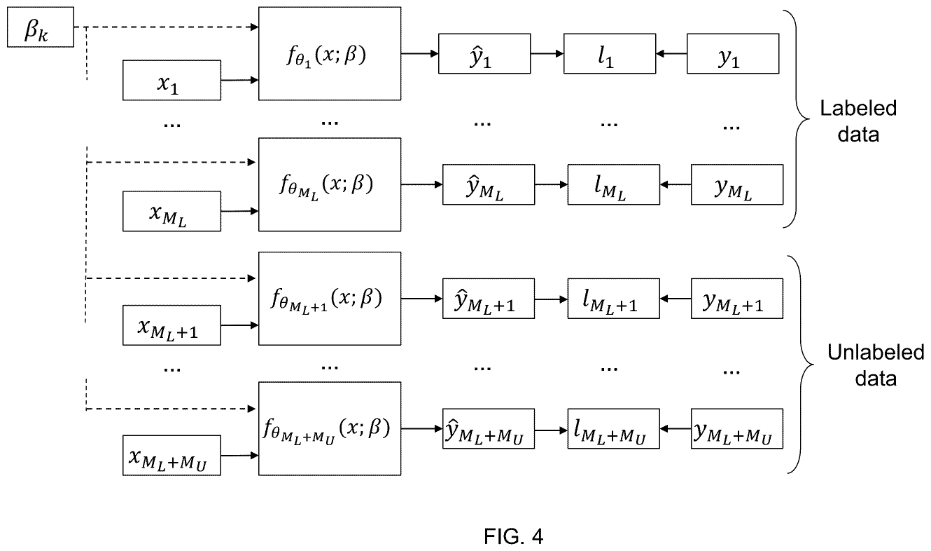

FIG. 4 depicts a semi-supervised multi-task learning model.

The following description relates to an embodiment of the invention that comprises use of both semi-supervised learning (SSL) and multi-task learning (MTL) techniques. MTL techniques, also termed transfer learning techniques, used in the context of data-driven parametric modelling for modelling one or more production wells are described and disclosed further in applicant's patent publication WO 2021/206565 A1. The multi-task learning techniques disclosed in WO 2021/206565 may be suitably incorporated in embodiments of the current invention as will be appreciated by the skilled person, in particular as will be elucidated by the following description.

The training of the model as described below results in a model that can allow for later modelling of production wells, for example for prediction or estimation purposes as described above. Such modelling can allow for analysis of production performance of the production wells and/or improving or optimisation of production performance

The process of multi-task learning, where a model is trained on multiple tasks (e.g. predicting well flow on different wells), may be illustrated as in FIG. 3. Here x and y are measurements, θ is a parameter that is common for all tasks, and β is a latent (unobserved) parameter which encodes the context or individual characteristics of different tasks (e.g. physical parameters which differ between wells).

Let k ∈ {1, . . . , K} refer to a context, j ∈{1, . . . , J} refer to a task, and i ∈ {1, . . . , N_{k,j}} refer to a data point. For instance, context k may refer to a given oil well, task j may refer to the problem of estimating well flow, and i would then index a single flow rate measurement for this particular well. N_{k,j} denotes the number of available data points for task j in context k.

To distinguish between the nature of different labels, the number of tasks M can be split into M_{L} supervised tasks and M_{U} unsupervised tasks, where M=M_{L}+M_{U}>0. While the number of data points for a given task may vary between contexts, M_{L} and M_{U} will (without loss of generality) be defined equally for all contexts. If there are zero unsupervised tasks (M_{U}=0), then the learning algorithm is supervised. If there are zero supervised tasks (M_{L}=0), then the learning algorithm is unsupervised. If there are both supervised and unsupervised tasks (M_{L}>0 and M_{U}>0), then the learning algorithm is semi-supervised.

Given these index sets, the value of data point i which serves as an input to task j in context k is denoted x_{k,j,i}, and the value of the corresponding output is denoted y_{k,j,j}. For task j, in context k, the data is modelled by the function:

ŷ_{k,j,i}=f_{β}_{ₖ}_{θ}_{ⱼ}(x_{k,j,i})

Here, where ŷ_{k,j,i} is an estimate of y_{k,j,i} k are context-specific parameters, and j are task-specific parameters.

FIG. 4 shows a semi-supervised multi-task learning model for a single data point i in a context k. The indices i and k are omitted in FIG. 4 for the x and y variables. The model structure as shown in FIG. 4 may be trained on both labelled and unlabelled process data by predicting M_{L} labelled outputs y₁; . . . ; y_{ML} and M_{U} unlabelled outputs y_{ML+1}; . . . ; y_{ML+MU}. The labelled outputs may be any measurement which is predictable from x. The unlabelled outputs may be any quantity derivable directly from x. There is an important difference between how these two kinds of labels introduce information: the labelled outputs introduce new information from actual measurements/observations yⱼ, while the unlabelled outputs do not contain new measurements, but rather augments the unlabelled dataset with derived values yⱼ using prior knowledge of desired model behaviour. To emphasise their similar treatment in the modelling and optimization procedures, both of these types of outputs will be denoted yⱼ. The index j will then implicitly define what kind of information output yⱼ describes.

In the proposed model structure, the βₖ parameter may change between contexts, but is shared across tasks (and data points). If two different objectives share any common explanatory factors, βₖ should be able to pick it up, and improving performance on one task should improve performance on the other task as well due to an improved estimate of the βₖ parameter.

For a single context-task pair (k, j), the model parameters (βₖ, θ) may be estimated by minimizing a loss function lⱼ over all available data points N_{k,j}. We denote the total loss for context-task pair (k, j) by:

$${L}_{k , j} ( {β}_{k} , {θ}_{j} ) = {\sum }_{i = 1}^{{N}_{k , j}} {ℓ}_{j} ( {y}_{k , j , i} , {f}_{{β}_{k} , θ} , ( {x}_{k , j , i} ) ) .$$

The loss function lⱼ may differ between tasks and may accommodate both scalar and categorical outputs. For example, if lⱼ is a negative log-likelihood loss, then it may be specified by the normal distribution for scalar outputs and the multinomial distribution for categorical outputs. The above loss may be augmented by adding a regularization term, denoted R, on a subset of the parameters. The regularization term is used to control model complexity so that overfitting is avoided. The model parameter estimates are then found by solving:

$$( {β}_{k}^{*} , {θ}_{j}^{*} ) = {arg min}_{{θ}_{j} , {β}_{k}} {L}_{k , j} ( {β}_{k} , {θ}_{j} ) + R ( {θ}_{j} ) + R ( {β}_{k} )$$

When estimating the set of all the model parameters (β₁; . . . ; βₖ, θₜ; . . . ; θ_{M}) however, these individual loss functions cannot simply be optimized independently. Since each θⱼ is shared across contexts and each βₖ is shared across tasks, the different loss functions will depend on each other. These dependencies are the mechanism that enable learning across tasks (via the P-parameters) and across contexts (via the θ-parameters). The total loss over all available data, and all context-tasks pairs, is given by:

$$L = {\sum }_{k = 1}^{K} {\sum }_{j = 1}^{M} {λ}_{k , j} {L}_{k , j} ( {β}_{k} , {θ}_{j} ) + R ( {θ}_{j} ) + R ( {β}_{k} ) = {\underbrace{{\sum }_{k = 1}^{K} {\sum }_{j = 1}^{{M}_{L}} {λ}_{k , j} {L}_{k , j} ( {β}_{k} , {θ}_{j} ) + R ( {θ}_{j} )}}_{Supervised tasks} + {\underbrace{{\sum }_{k = 1}^{K} {\sum }_{j = {M}_{L} + 1}^{{M}_{L} + {M}_{U}} {λ}_{k , j} {L}_{k , j} ( {β}_{k} , {θ}_{j} ) + R ( {θ}_{j} )}}_{tasks} + {\underbrace{{\sum }_{k = 1}^{K} R ( {β}_{k} )}}_{Reg . of context parameters} .$$

In this equation the terms related to supervised and unsupervised tasks have been grouped. Each λ_{k,j} is a scalar which weighs the importance of performing well on each task-context pair. This may be simplified by assuming that the relative importance of each task is constant between contexts, resulting in weights λⱼ only ranging over tasks, resulting in simpler hyperparameter searches.

For brevity, all model parameters in the set can be collected as follows:

θ=(β1; . . . ;βk,θ1; . . . ;θM)

In that way, since the total loss in as above is a function of all model parameters, the notation for the total loss can be simplified as follows:

L=L(Θ)

The model parameter estimates may be found by any optimization scheme which minimizes the total loss in L=L(Θ). These estimates are denoted:

\hat{Θ}=^{argmin}_{Θ}L(Θ)

Using parametric models, e.g. neural networks, optimization is typically performed by a gradient descent method. Denote by \hat{Θ}^{(l)} the parameter estimates at iteration I of the optimization procedure. Gradient descent updates the parameters as follows:

$${\hat{Θ}}^{{}_{( l + 1 )}} = {\hat{Θ}}^{{}_{( l )}} - {α}_{l} {∇}_{Θ} L {{{}^{\hat{Θ}}}^{( l )}}_{}$$

The term V̅_{Θ}L [symbol] _{\hat{Θ}}_{^{(l)}} is the gradient of L with respect to Θ evaluated at \hat{Θ}^{(l)}. Gradient descent iterates until some termination criterion is met. Commonly, the optimization is terminated when the model no longer improves on a validation loss (computed as the loss in L evaluated on validation data, disregarding the two regularization terms).

A decision has to be made on which order the different parts of the total loss are minimized in. With the training procedure stated above, all tasks (for all contexts) are simultaneously trained and the loss is computed using all data. While this may be suitable for some problems, it may be better to sequentially train on subsets of tasks and contexts. For example, if some tasks are considered as being secondary to the application of the model, then one may pre-train on these tasks, before fine-tuning the model on the primary tasks. Other mechanisms are also possible, for example alternated training on task-context subsets. The training procedure will influence the final model. For example, the distribution of a latent representation in an auto-encoder may be better suited for regressing onto a variable y than for reconstructing x, if the model is fine-tuned on a supervised regression task with labels on y.

Furthermore, the training may be done by optimizing on approximations of L. For a given iteration in the optimization, L can be approximated by computing on a random subset of the full dataset D. This is a common approach in machine learning and is termed (mini-batch) stochastic gradient descent. For large datasets (typically with more than 10⁵ data points), this may result in a more efficient optimization.

There are many different variations of the basic gradient descent algorithm, and they are all applicable to the above optimization problem.

An important property of gradient descent methods is the dependency of time. This dependency may be exploited by introducing a time dependency in λ as well. For instance, one may let λ_{k,1}=0 and λ_{k,2}; . . . ; λ_{k,2}; . . . ; λ_{k,M}=0 for an initial period of time (number of epochs), and then switch and let λ_{k,1}>0 and λ_{k,2}; . . . ; λ_{k,M}=0. This is a procedure of pre-training the model on unlabelled data, and fine-tuning it on labelled data. The values of λ can also change continuously in time, for instance the labelled data may be gradually introduced and data from the tasks least relevant to the main objective may be phased out.

With regard to the parameters β and θ, for context k, the context-specific parameters βₖ are shared among the M tasks. For a given task j, the task-specific parameters θⱼ are shared among all K contexts.

This means that θⱼ stores knowledge which is important to solving task j, independently of the context. The βₖ parameter captures the specificity of context k and allows the model to adjust its predictions for the M tasks to this context.

1. A method of training a parametric model, the method comprising:
training a parametric model for describing, for one or more production wells, a relationship between one or more flow parameters, and/or one or more well parameters and/or an associated status of at least one control point associated with the one or more production wells, wherein the training uses unlabeled production data relating to the one or more production wells, and comprises:
minimizing an unsupervised loss function for the parametric model based on the unlabeled production data; and
estimating model parameters of the parametric model based on the minimizing of the unsupervised loss function.

2. The method of claim 1, wherein the unsupervised loss function is set-up such that it can be used to conduct consistency training.

3. The method of claim 1, wherein the unsupervised loss function and the parametric model are part of an autoencoder.

4. The method of claim 1, wherein the training further uses labeled production data relating to the one or more production wells, and comprises:
minimizing a supervised loss function for the parametric model based on the labelled production data; and
estimating model parameters of the parametric model based on the minimizing of the supervised loss function.

5. in the method of claim 4, wherein the steps of minimizing the supervised loss function and minimizing the unsupervised loss function are performed by minimizing a total loss function, and wherein the steps of estimating model parameters based on the minimizing of the unsupervised loss function and based on the minimizing of the supervised loss function are performed by estimating model parameters based on the minimizing of the total loss function.

6. The method of claim 1, where the step of minimizing the unsupervised loss function and the step of estimating model parameters of the parametric model form part of a regression problem.

7. The method of claim 1, wherein the parametric model is for describing for a plurality of production wells a relationship between one or more flow parameters, one or more well parameters and/or an associated status of the at least one control point.

8. The method of claim 1, wherein the step of minimizing the unsupervised loss function comprises a gradient descent method.

9. The method of claim 1, wherein the parametric model comprises context-specific model parameters that are each representative of one or more properties common to a respective context to which the context-specific model parameter relates.

10. in the method of claim 9, wherein each context is a respective production well and each context-specific parameter is a well-specific parameter.

11. The method of claim 9, wherein each context is a respective set of production wells and each context-specific parameter is a parameter specific to a respective set of production wells.

12. The method of claim 1, wherein the parametric model is for describing, for the one or more production wells, a plurality of relationships between flow parameters, and/or well parameters, and/or an associated status of the at least one control point.

13. The method of claim 1, wherein the parametric model comprises a plurality of task-specific model parameters that are each representative of one or more properties common to a respective task to which the task-specific model parameter relates.

14. The method of claim 13, wherein each task is flow-rate estimation and the model comprises flow-rate-estimation-specific parameters.

15. A parametric model for describing, for one or more production wells, a relationship between one or more flow parameters, and/or one or more well parameters, and/or an associated status of at least one control point associated with the one or more production wells, wherein the parametric model has been trained in accordance with the method of claim 1.

16. A method of modelling, for one or more production wells, a relationship between one or more flow parameters, and/or one or more well parameters, and/or an associated status of at least one control point, wherein the method comprises:
training a parametric model in accordance with the method of claim 1; and
modelling, for the one or more production wells, a relationship between one or more flow parameters, and/or one or more well parameters, and/or an associated status of at least one control point, using the trained parametric model.

17. The method of claim 16, wherein the modelling comprises estimating one or more flow parameters, and/or one or more well parameters, and/or the status of at least one control point, for the one or more production wells.

18. The method of claim 17, comprising estimating, for a point of time in the past, one or more flow parameters, and/or one or more well parameters, and/or the status of at least one control point, for the one or more production wells.

19. The method of claim 18, comprising estimating, for the point of time in the past, a pressure, and/or a temperature, and/or a flow rate, where no data is otherwise available for the point of time in the past for the pressure, and/or the temperature, and/or the flow rate.

20. A method of analyzing production performance for one or more production wells, the method comprising:
estimating one or more flow parameters, and/or one or more well parameters, and/or the status of at least one control point, in accordance with the method of claim 17; and
analyzing production performance for the one or more production wells based on the one or more estimated flow parameters, and/or the one or more estimated well parameters, and/or the status of at least one control point.

21. The method of claim 16, wherein the modelling comprises predicting one or more potential future flow parameters, and/or one or more potential future well parameters, and/or a potential future status of the at least one control point, for the one or more production wells.

22. A method of determining predicted production performance for one or more production wells, the method comprising:
(i) providing a proposed change in one or more well parameters, and/or one or more flow parameters, and/or a status of at least one control point associated with the one or more production wells;
(ii) predicting, based on the proposed change, one or more flow parameters, and/or one or more well parameters, and/or the status of at least one control point, for the one or more production wells in accordance with the method of claim 21; and
(iii) determining predicted production performance for the one or more production wells based on the predicted one or more flow parameters, and/or one or more well parameters, and/or the status of the at least one control point.

23. The method of claim 22, wherein steps (i) to (iii) are repeated until a desired improvement in production performance is determined.

24. The method of claim 23, wherein steps (i) to (iii) are repeated until optimized production performance is determined.

25. A method of improving or optimizing production performance for one or more production wells, the method comprising:
determining an improved or optimized production performance for the one or more production wells by repeating steps (i) to (iii) of the method of claim 22 until a desired improved or optimized production performance is determined; and
altering the one or more flow parameters, and/or the one or more well parameters, and/or the status of the at least one control point associated with the one or more production wells, for conformity with the predicted one or more flow parameters, and/or the predicted one or more well parameters, and/or the predicted status of the at least one control point, that give rise to the improved or optimized production performance.

26. A computer system configured to train a parametric model for describing, for one or more production wells, a relationship between one or more flow parameters, and/or one or more well parameters, and/or an associated status of at least one control point associated with the one or more production wells, wherein the training uses unlabeled production data relating to the one or more production wells, and comprises:
minimizing an unsupervised loss function for the parametric model based on the unlabeled production data; and
estimating model parameters of the parametric model based on the minimizing of the unsupervised loss function.

27. A non-transitory computer-readable medium comprising instructions for execution on a computer system, wherein the instructions, when executed, will-configure the computer system to train a parametric model for describing, for one or more production wells, a relationship between one or more flow parameters, and/or one or more well parameters, and/or an associated status of at least one control point associated with the one or more production wells, wherein the training uses unlabeled production data relating to the one or more production wells, and comprises:
minimizing an unsupervised loss function for the parametric model based on the unlabeled production data; and
estimating model parameters of the parametric model based on the minimizing of the unsupervised loss function.

28. The method of claim 1, wherein the one or more production wells are one or more hydrocarbon production wells.

29. The method of claim 1, wherein the minimizing of the unsupervised loss function is terminated when a termination condition is met.
